(19) United States
(12) Patent Application Publication
(10) Pub. No.: US 2022/0287460 A1
(43) Pub. Date: Sep. 15, 2022

(54) MAGNETIC SEPARATOR FOR DRAWERS AND DRAWER SYSTEM INCLUDING THE SAME

(71) Applicant: SAMET KALIP VE MADENI ESYA SAN VE TIC. A.S, Istanbul (TR)

(72) Inventors: Nurettin GUZELTEPE, Istanbul (TR); Mehmet BEKTAS, Istanbul (TR)

(73) Assignee: SAMET KALIP VE MADENI ESYA SAN VE TIC. A.S, Istanbul (TR)

(21) Appl. No.: 17/632,904

(22) PCT Filed: Aug. 6, 2019
(86) PCT No.: PCT/TR2019/050652

§ 371 Date: Feb. 4, 2022

(51) Int. Cl. A47B 88/975; F16B 1/00

(52) U.S. Cl. CPC A47B 88/975; F16B 1/00; F16B 2001/0035

(57) ABSTRACT

A magnetic separator allowing users to organize an interior of a drawer in accordance with needs of the users. The separator is fixed to sidewalls of the drawer and each other within a desired dimension range, allows an arrangement of the interior of the drawer by changing a location and geometry of the separator when needed, allows the interior of the drawer to be organized without being restricted to 90 degree angles by holders placed at ends of the separator and the holders contain a magnet within interiors of the holders, thus allows the users to create organizations within the interior of the drawer.

### CROSS REFERENCE TO THE RELATED APPLICATIONS

This application is the national stage entry of International Application No. PCT/TR2019/050652, filed on Aug. 6, 2019, the entire contents of which are incorporated herein by reference.

### TECHNICAL FIELD

The present invention relates to a magnetic separator (divider) which allows the users to organize the interior of the drawer in accordance with their needs.

Specially, the present invention relates to a separator which can be fixed to the drawer sidewalls and to each other in a practical and easy way within the desired dimension range, allows the arrangement of the drawer interior efficiently and practically by changing its location and geometry easily when needed, allows the drawer interior to be organized without being restricted to 90 degree angles thanks to the holders (for example; plastic) that are placed at its ends and that contain mentioned magnet within their interiors, thus allows the users to create their organizations within the drawer interior without being restricted with the standards, provides easy usage and assemble as well as all of them, and relates to a drawer system including the same.

### BACKGROUND

The parts used as separator within the drawer are fixed at the certain points to the drawer sidewall and/or to each other and, thus an arrangement where the user's objects serving for different purpose can be separated from each other and the user's object serving for the same purpose can be kept together is provided. Fixing of the separators at the certain points in accordance with standards causes the users to not be able to organize efficiently the drawer interior according to their personal requirements and creates limited usage problem within the drawer by restricting the change of organization according to the user's instant needs.

The document EP2100537A describes modular separator allowing the users to organize the drawer interior according to their personal needs. However, mentioned modular organization has two separation walls which are parallel to each other and placed with interval, and two side-separation walls disposed between these separation walls. The connection between these elements is provided by a connection unit. However, there is no solution which includes magnet at the ends and consequently, which allows the users to change easily and practically the drawer interior in accordance with the users' changing needs.

As a result, the need for separator which provides efficient storage by allowing the users to determine the organization of the drawer interior according to their needs without being restricted to standards, allows easy and practical change of the organization within the drawer according to the users' changing needs, provides easy usage and assemble as well as all of them and, for drawer system therefore caused the present innovative solution to emerge.

### SUMMARY

The aim of the present invention is to provide a separator which provides efficient storage by allowing the users to determine the organization of the drawer interior according to their needs without being restricted to standards, allows easy and practical change of the organization within the drawer according to the users' changing needs, provides easy usage and assemble as well as all of them, and to provide a drawer system including the same.

Another aim of the present invention is to provide fixing to the drawer sidewalls and each other in a practical and easy way within the desired dimension range thanks to the magnet inserted within its end portions.

Another aim of the present invention is to allow efficient and practical organization of the drawer interior by changing its location and geometry easily when needed.

Another aim of the present invention is to allow the drawer interior to be organized without being restricted to 90 degree angles by the holders that contain mentioned magnet within their interiors. Another aim of the present invention is to allow the practical fixing and, easy assemble and disassemble of the separators.

Another aim of the present invention is to provide easy and ergonomic usage without being restricted by dimensions.

### BRIEF DESCRIPTION OF THE DRAWINGS

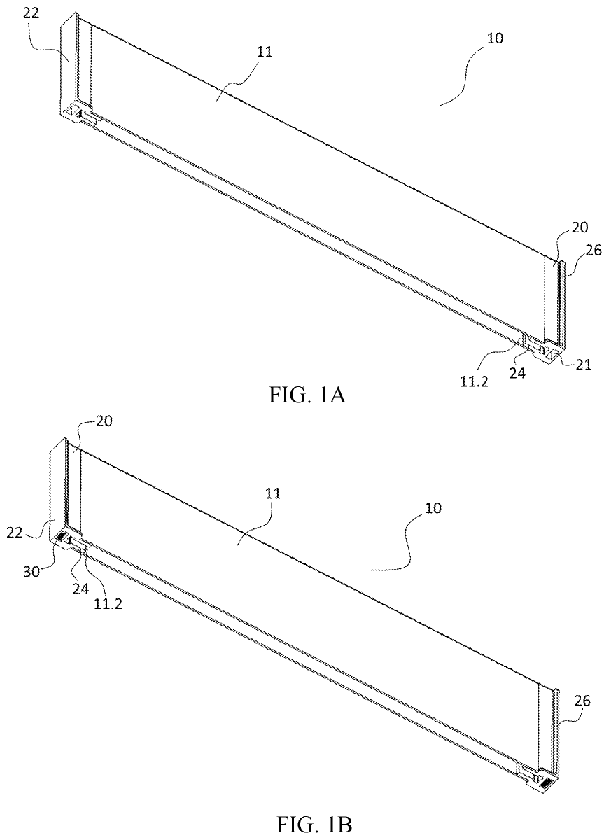

In FIG. 1A, a bottom perspective view of present separator comprising holders which have wide surface at the contact points and have not yet magnet within its inner space is given.

In FIG. 1B, a bottom perspective view of mentioned present separator comprising holders which have wide surface at the contact points and have magnet within its inner space is given.

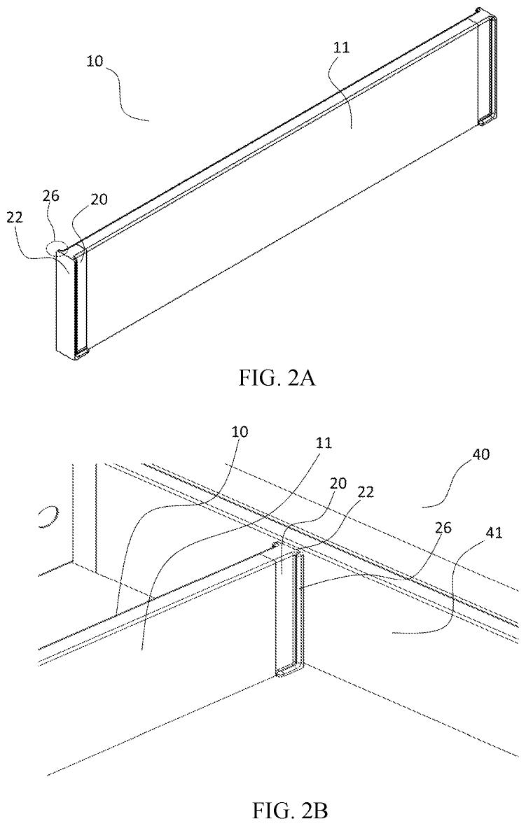

In FIG. 2A, a top perspective view of mentioned separator comprising holders having wide surface at the contact points is given.

In FIG. 1B, a close perspective view of a drawer separated into sections by using present separator comprising holders having wide surface at the contact points is given.

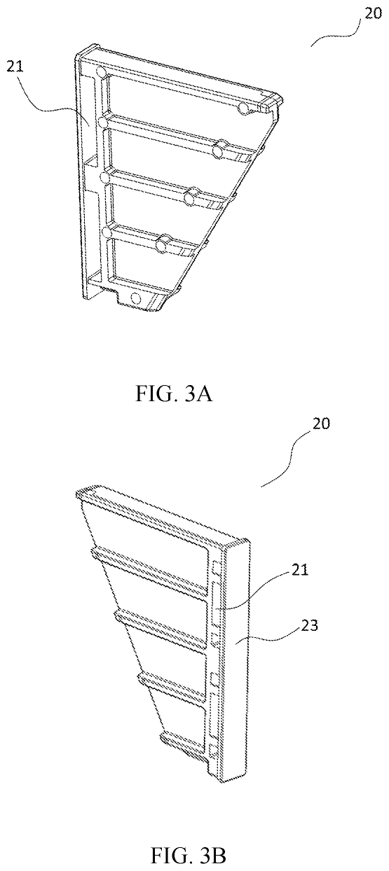

In FIG. 3A, a perspective view of a preferred embodiment of the holder which comprises inner spaces for allowing the magnet to be inserted within, which has narrow surface at the contact points, which is inserted within the separator from the both end of the separator is given.

In FIG. 3B, a perspective view of an another preferred embodiment of the holder which comprises inner spaces for allowing the magnet to be inserted within, which has narrow surface at the contact points, which is inserted within the separator from the both end of the separator is given.

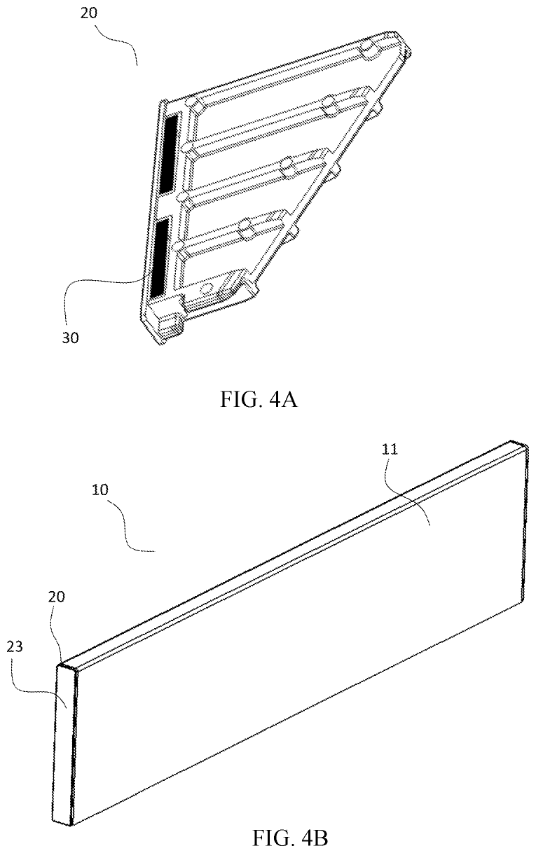

In FIG. 4A, a perspective view of the holder which comprises magnet within its inner space portions, which has narrow surface at the contact points, which is inserted within the separator from the both end of the separator is given.

In FIG. 4B, a perspective view of the separator, in which the holders having narrow surface are inserted to its both ends, is given.

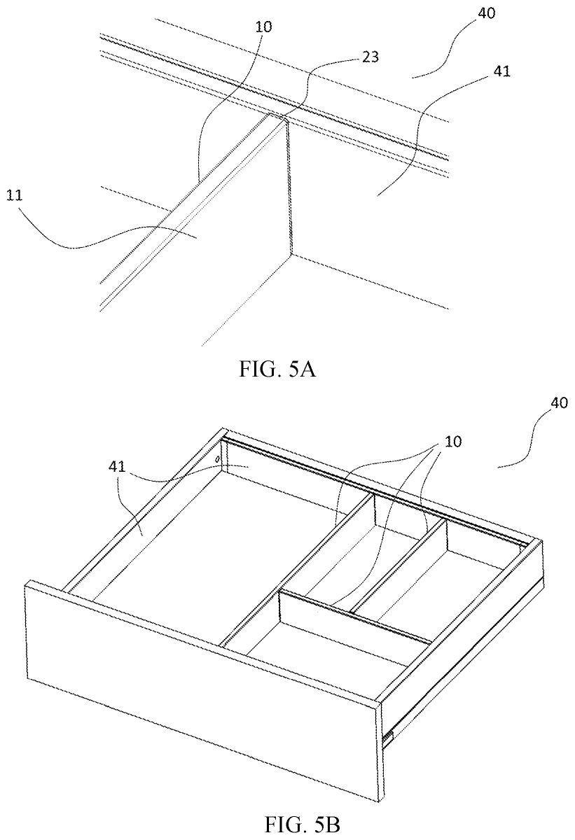

In FIG. 5A, a close perspective view of a drawer which is separated into sections by using present separator comprising holders having narrow surface at the contact points is given.

In FIG. 5B, a perspective view of mentioned drawer which is separated into sections by using present separator comprising holders having narrow surface at the contact points is given.

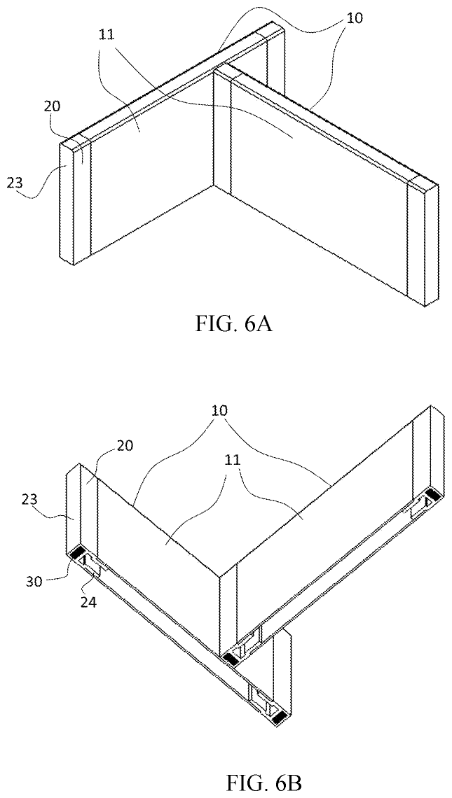

In FIG. 6A, a top perspective view of two separators which are positioned to each other as perpendicular and which comprise holders having narrow surface at the contact points is given.

In FIG. 6B, a bottom perspective view of mentioned two separators which are positioned to each other as perpendicular and which comprise holders having narrow surface at the contact points is given.

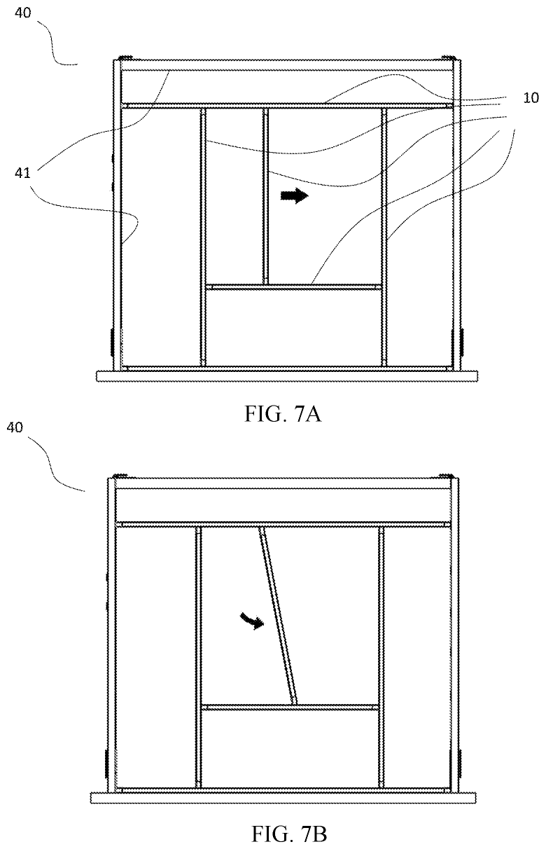

In FIG. 7A, a top view of a preferred embodiment of drawer layout formed by the contact of multiple separators with each other and the drawer sidewalls, in which separators include holding parts having a narrow surface at the contact points, is given.

In FIG. 7B, a top view of an another preferred embodiment of drawer layout formed by the contact of multiple separators with each other and the drawer sidewalls, in which separators include holding parts having a narrow surface at the contact points, is given.

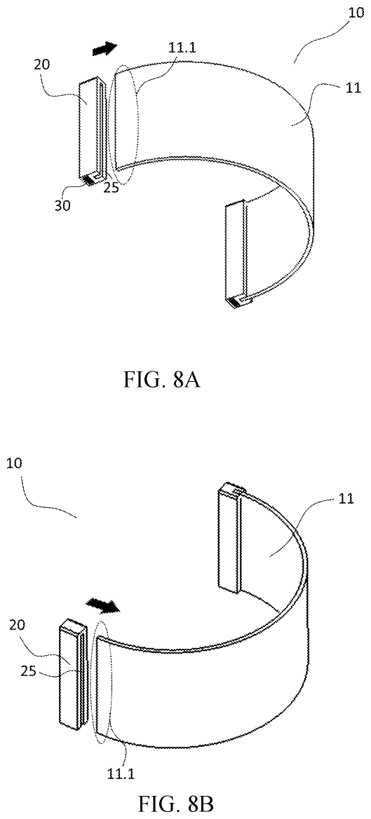

In FIG. 8A, a bottom perspective view of a preferred embodiment of separator of the present invention, which having round surface, providing minimum space loss by offering flexible solution options, with holder parts located in its end portions having fixing slot, is given.

In FIG. 8B, a top perspective view of a preferred embodiment of separator of the present invention, having round surface, providing minimum space loss by offering flexible solution options, with holder parts located in its end portions having fixing slot, is given.

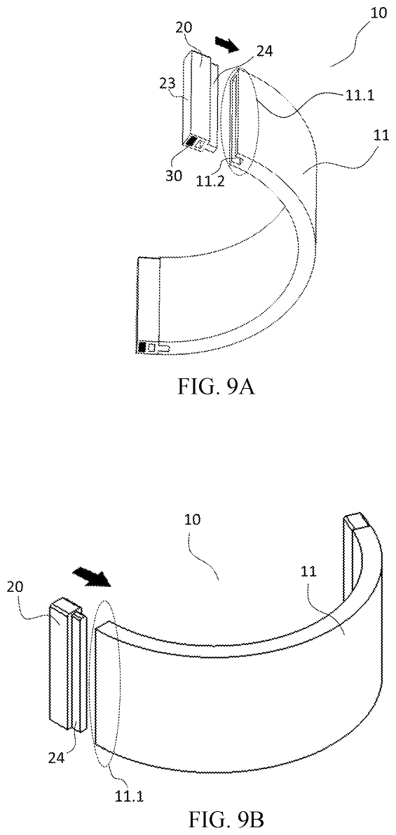

In FIG. 9A, a bottom perspective view of an another preferred embodiment of separator of the present invention, which having round surface, providing minimum space loss by offering flexible solution options, with holder parts having fixing protrusion located in fixing cavity on its end parts, is given.

In FIG. 9B, a top perspective view of an another preferred embodiment of separator of the present invention, which having round surface, providing minimum space loss by offering flexible solution options, with holder parts having fixing protrusion located in fixing cavity on its end parts, is given.

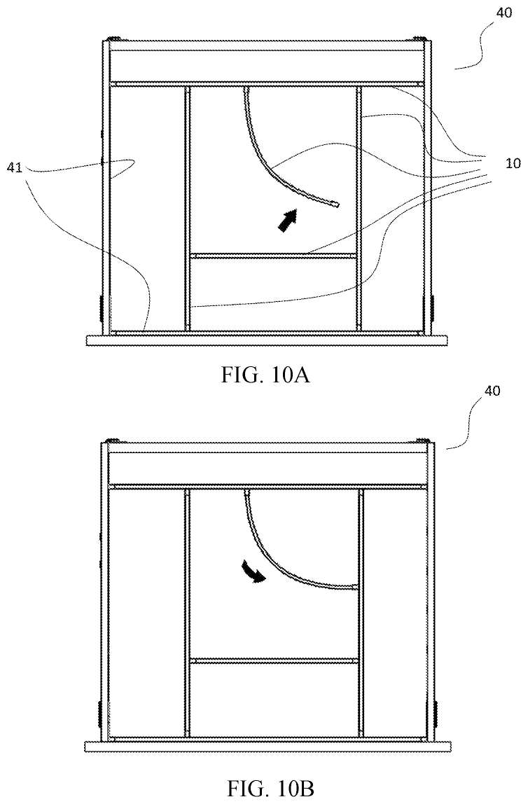

In FIG. 10A, a top view of showing that the diameter of the separator which has round and flexible surface can be changed according to necessity, is given.

In FIG. 10B, a top view of flexible drawer layout formed by the contact of separator, which has round and flexible surface, with other separators is given.

### REFERENCE NUMBERS IN THE FIGS

10. Separator
11. Body
11.1. End portion
11.2. Fixing cavity
20. Holder
21. Inner space
22. Wide surface
23. Narrow surface
24. Fixing protrusion
25. Fixing slot
26. Protrusion
30. Magnet
40. Drawer
41. Drawer sidewall

### DETAILED DESCRIPTION OF THE EMBODIMENTS

The present invention relates to a separator (10) which provides efficient storage by allowing the user to define the drawer (40) layout in accordance with his needs without being restricted with the standards, allows easy and practical modification of the arrangement in accordance with the changing needs of the user, as well as provides easy usage and assemble, and to the drawer (40) system including said separator (10).

According to the present invention, the separator (10) comprises; a body (11) which is able to be formed in different geometries, dimensions and flexibility so as to divide internal space of the drawer (40) into which it will be placed; two holders (20) secured to the end portions (11.1) of said body (11), providing friction-induced grip with the other separator (10) and/or drawer sidewall (41) to which it is in contact with the contact surface due to its material, and allowing contact at desired angles; the magnet (30) which creates magnetic attraction between two separators (10) or the separator (10) and the drawer sidewall (41) by placing it between said holders (20) or in the inner space (21) located therein thus allowing the parts to be fixed to each other at the desired points and angles via said magnetic attraction.

It is possible to place the magnet in the separators (10), besides being able to be located between said holders (20) or in the inner space (21) located within said holders (20). In this way, the separators (10) in various sizes are fixed to the drawer sidewalls (41) or to the other separators (10) at desired points flexibly (by forming round surface) or perpendicularly, etc. in the drawer according to the needs of the user.

In a preferred embodiment of the present invention, the body (11) is made of metal material.

In a preferred embodiment of the present invention, the body (11) comprises metal.

In a preferred embodiment of the present invention, the body (11) is in the form of sheet metal.

In a preferred embodiment of the present invention, the body (11) is in the form of sheet metal folded in two with gap between.

In a preferred embodiment of the present invention, the holders (20) are made of flexible material.

In a preferred embodiment of the present invention, the holders (20) comprise fixing slot (25) and the separator (10) is obtained by placing the end portions (11.1) of the body (11) into said fixing slot (25). Herein, a body (11) in the form of sheet metal or made of elastic material can be used. The related images of this embodiment are given in FIGS. 8A and 8B.

In a preferred embodiment of the present invention, the holders (20) comprise fixing protrusion (24) and the separator (10) is obtained by placing it in the fixing cavity (11.2) formed at the end portions (11.1) of the body (11) corresponding to said fixing protrusion (24). Herein, it is possible to use a body (11) in the form of sheet metal or elastic material comprising the fixing cavity (11.2) corresponding to the fixing protrusion (24) at the end portions (11.1), or a body (11) which is folded in half to form a fixing cavity (11.2) corresponding to the fixing protrusion (24) at the end portions (11.1).

The images belongs to body (11) structure, in the form of sheet metal comprising fixing cavity (11.2) corresponding to the fixing protrusion (24) at the end portions (11.1), are provided in FIGS. 1A, 1B, 6B, 9A and 9B. The body (11) structure given in FIGS. 9A and 9B can easily be twisted to different diameters to arrange the products having cylindrical round surface or soft amorphous forms with variable packaging by its flexible structure. Furthermore, it is also possible to use a body (11) structure with a structure rising towards its middle part, if required. Thus, this embodiment provides a useful structure particularly for separating materials stored in deep drawers, with its flexible structure, customizable dimensions and geometry. It is aimed to eliminate space loss with this flexible structure by the virtue of structural adaptation to the shapes of the goods. The top views of the drawer arrangement using said flexible body form are provided in FIG. 10A and FIG. 10B, respectively. Such body structures may be partially bent in different diameters, or may be bent until the holders (20) at each end contact with each other and engage with the effect of the magnet (30). Thus, in a further preferred embodiment, it is also possible to form a cylindrical chamber within the drawer (40) for goods like pen and so on.

In a preferred embodiment of the present invention, sheet metal separators (10) can be fixed to be parallel to each other with the drawer sidewall, thereby it is possible to provide a compartment to form notes, small cards and invoices that users do not know where to place in the drawer (40). It is also possible to use a number of such separators parallel to each other due to the magnet (30) feature. Thus, small note papers, cards and invoices can be arranged in themselves.

FIGS. 3A, 3B and 4A show perspective views of a preferred embodiment of the holder (20) placed into the separator (10) at both ends, comprise a narrow surface at the points of contact and comprising inner space (21) in which the magnet (30) can be placed. In FIGS. 4B, 5A, and 5B, perspective views of the separator (10) comprising said holder (20) at the end portions (11.1) as well as connection and drawer arrangements obtained with such separators (10) are provided.

In preferred embodiments of the present invention, in order to ensure that the holder (20) contacts a wider surface in the contacts made by the separators (10) with each other and/or with the drawer sidewall (41) so that to ensure that the separators (10) positioned (by the magnetic force) vertically in the drawer (40) do not tip over, there are protrusions (26) on the ends of the holders (20), which can also be called elephant legs (large surface model). Said projections (26) shown in FIGS. 1A, 1B, 2A, and 2B provide increase in contact surface between two parts during contact of holder (20) with other part, it also increases the force value required for tipping of the separator (10). While it is desired to create a magnet force supporting effect with the holder (20) comprising a large surface (22) due to presence of protrusion (26) on its end, it is desired to achieve a more simple and minimal effect with the holder (20) comprising narrow surface (23) due to absence of protrusion (26). The frequency of problems such as tipping varies according to the material used in the holder (20). Therefore, depending on the adhesion of the holding material used (the size of the friction coefficient), it may not be necessary to use the protrusion (26) on all of the holders (20). Perspective views of the separators (10), which comprising holders (20) with narrow surface (23) at the end portions (11.1), which positioned perpendicular to each other, are given in FIGS. 4B, 6A, 6B, 8A, 8B, 9A, and 9B. In FIGS. 5A, 5B, 7A, 7B, 10A, and 10B, top views of different drawer (40) arrangements provided by using said separators (10), which comprising holders (20) with narrow surface (23) at the end portions (11.1), are given.

Thanks to the flexibility of the retaining parts (20) at the ends of the separators (10), the separators (10) are allowed to move-bend to the right-left directions at certain angles. Thus, it may be possible to arrange the interior of drawer regardless of the 90 degree angle.

In addition, it is also possible to create a visually strong effect by offering different color combinations for holders (20) and bodies (11). The holders (20) may be transparent.

While creating or changing drawer interior layout, thanks to the magnet in the inner cavity (21) of said holders (20), the separators (10) can be fixed in the desired size range and where required they can easily be relocated in a practical and easy way. It becomes possible to create a more efficient and personal order by separating the separators (10) in the desired size range.

The drawer (40) system of the present invention comprises at least one separator (10). The drawer (40) arrangement can be structured according to the personal needs of the user and instant changes can be applied in line with the changing needs of the user, by the positioning of the separators (10) with each other and with the drawer sidewalls (41) at different angles and geometries.

What is claimed is:

1. A separator allowing a user to organize an internal space of a drawer according to needs of the user, comprising a body, the body is configured to be formed in different geometries and sizes to divide the internal space of the drawer, wherein the body is placed in the internal space of the drawer and comprising a magnet at end portions of the body.

2. The separator according to claim 1, further comprising
two holders secured to the end portions of the body, providing a friction-induced grip with the separator and/or a drawer sidewall wherein the two holders are in contact with a contact surface due to a material of the two holders, and allowing contact at desired angles, and
the magnet is located between the two holders or in an inner cavity of the two holders.

3. The separator according to claim 1, wherein the body is made of a metal.

4. The separator according to claim 1, wherein the body comprises a metal material.

5. The separator according to claim 1, wherein the body is in a form of a sheet metal.

6. The separator according to claim 1, wherein the body is in a form of a sheet metal folded in two with a gap between.

7. The separator according to claim 1, wherein the body comprises a fixing cavity formed at the end portions.

8. The separator according to claim 2, wherein the two holders are made of an elastic material.

9. The separator according to claim 2, wherein the body further comprises fixing cavities at the end portions, and the two holders have a fixing protrusion.

10. The separator according to claim 2, wherein the two holders comprise fixing slots corresponding to the end portions of the body.

11. The separator according to claim 2, wherein the separator has a flexible structure allowing partially bent in different diameters or wholly bent to form a cylindrical chamber.

12. A drawer system arranged to allow the user to organize the internal space of the drawer by comprising at least one separator according to claim 1.

13. The drawer system according to claim 12, further comprising
two holders secured to the end portions of the body, providing a friction-induced grip with the separator and/or a drawer sidewall wherein the two holders are in contact with a contact surface due to a material of the two holders, and allowing contact at desired angles, and
the magnet is located between the two holders or in an inner cavity of the two holders.

14. The drawer system according to claim 12, wherein the body is made of a metal.

15. The drawer system according to claim 12, wherein the body comprises a metal material.

16. The drawer system according to claim 12, wherein the body is in a form of a sheet metal.

17. The drawer system according to claim 12, wherein the body is in a form of a sheet metal folded in two with a gap between.

18. The drawer system according to claim 12, wherein the body comprises a fixing cavity formed at the end portions.

19. The drawer system according to claim 13, wherein the two holders are made of an elastic material.

20. The drawer system according to claim 13, wherein the body comprises fixing cavities at the end portions, and the two holders have a fixing protrusion.
